(19) United States
(12) Patent Application Publication
(10) Pub. No.: US 2026/0149242 A1
(43) Pub. Date: May 28, 2026

(54) MODULAR HIGH-VOLTAGE SWITCHING SYSTEM AND METHOD

(71) Applicant: MICATU INC., Horseheads, NY (US)

(72) Inventor: Michael Oshetski, Horseheads, NY (US)

(21) Appl. No.: 19/402,712

(22) Filed: Nov. 26, 2025

Related U.S. Application Data
(60) Provisional application No. 63/725,311, filed on Nov. 26, 2024.

(51) Int. Cl. H02B 1/04; H02B 1/21; H02B 1/24; H02B 1/50; H02B 1/56; H02B 13/035; H02B 13/055; H02J 3/00; H02J 3/01; H02J 13/00

(52) U.S. Cl. CPC H02B 1/04; H02B 1/21; H02B 1/24; H02B 1/50; H02B 1/56; H02B 13/0352; H02B 13/055; H02J 3/0012; H02J 3/01; H02J 13/10; H02J 13/34

(57) ABSTRACT

A high-voltage solid-state switching assembly for use in an electric power transmission, subtransmission, or distribution network. The assembly includes a press-pack semiconductor switching stack including solid-state switching devices connected in series. The assembly further includes a pressure-distribution mechanism including a pressure cone, compression plate, and spring system configured to maintain substantially uniform contact pressure across the press-pack semiconductor switching stack during thermal and electrical cycling. The assembly further includes a dielectric insulation chamber containing an insulating medium selected from air, nitrogen, insulating oil, fluorinated dielectric gas, SF₆-free insulating gas, and a combination thereof, the dielectric insulation chamber being dimensioned to provide required creepage and clearance distances for the intended system voltage. The assembly further includes a thermal-management arrangement including at least one of a heat sink, external fin, radiator plate, and convection-promoting channel configured to dissipate heat generated by the press-pack semiconductor switching stack during operation.

### TECHNICAL FIELD

The present disclosure generally relates to the electronic components enclosures. Particularly, the present disclosure relates to high-voltage switching devices for utility distribution networks, specifically those employing insulated-gate bipolar transistors (IGBTs) in press-pack configurations.

### BACKGROUND

High-voltage switching systems are used in electric power networks to control the flow of electricity at voltages typically above 1 kilovolt, and in utility applications often ranging from distribution-class voltages (4-35 kV) up to transmission-class voltages exceeding 500 kV. These systems enable operators to connect, disconnect, or reroute power under both normal and fault conditions, and are essential for grid reliability, maintenance, and safety. Utility distribution networks demand switching systems to ensure reliable power flow, effective fault isolation, and load balancing across interconnected feeder lines. However, current technologies face critical challenges, especially in medium-to high-voltage applications.

### SUMMARY

An aspect of a high-voltage solid-state switching assembly can include a press-pack semiconductor switching stack, a pressure-distribution mechanism, a dielectric insulation chamber, and a thermal-management arrangement. The high-voltage solid-state switching assembly can be deployed for use in an electric power transmission, subtransmission, and/or distribution network. The press-pack semiconductor switching stack can include a plurality of solid-state switching devices connected in series. The pressure-distribution mechanism can include a pressure cone, compression plate, and/or a spring system. The pressure-distribution mechanism can be configured to maintain substantially uniform contact pressure across the press-pack semiconductor switching stack during thermal and electrical cycling. The dielectric insulation chamber can contain an insulating medium, which can be selected from air, nitrogen, insulating oil, fluorinated dielectric gas, SF₆-free insulating gas, and a combination thereof. The dielectric insulation chamber can be dimensioned to provide required creepage and/or clearance distances for the intended system voltage. The thermal-management arrangement can include at least one of a heat sink, external fin, radiator plate, and convection-promoting channel. The thermal-management arrangement can be configured to dissipate heat generated by the press-pack semiconductor switching stack during operation.

In some embodiments, a press-pack semiconductor switching stack can include insulated-gate bipolar transistors (IGBTs), integrated gate-commutated thyristors (IGCTs), fast recovery diodes, and/or a combination thereof. Such elements can be rated for at least a 15 kV distribution-class application.

In other embodiments, a dielectric insulation chamber can include an insulating medium. The dielectric insulation chamber can be maintained at a pressure above atmospheric pressure to increase dielectric withstand strength.

In yet other embodiments, a thermal-management arrangement can be configured to dissipate heat generated during interruption and/or conduction of at least 600 A of line current at a nominal system frequency of 50 Hz or 60 Hz.

An aspect of a field-deployable high-voltage solid-state switching device can include a corrosion-resistant enclosure, a dielectric-filled internal compartment containing a press-pack semiconductor switching assembly, at least one high-voltage bushing and/or terminal configured for direct connection to an overhead and/or underground power conductor, and a mounting interface configured for attachment to at least one of a utility pole, a pad-mount foundation, a vault structure, and/or a substation rack. Such a device can be configured for deployment in transmission, subtransmission, and/or distribution networks. The corrosion-resistant enclosure can be sealed against moisture and environmental contaminants. The dielectric-filled internal compartment can house the press-pack semiconductor switching assembly in a manner providing electrical insulation and environmental protection. The mounting interface can enable secure installation in various utility environments.

In some embodiments, the corrosion-resistant enclosure can include at least one of powder-coated aluminum, stainless steel, and/or glass-fiber-reinforced polymer. The enclosure can include a gasketed access door to allow field maintenance of the press-pack semiconductor switching assembly.

In other embodiments, the mounting interface can include a base plate configured for bolting to a pad-mount foundation and can further comprise lifting lugs for hoisting the enclosure during installation and/or removal.

In yet other embodiments, the dielectric-filled internal compartment can include a removable internal tank that can be hermetically sealed and replaceable as a unit containing the press-pack semiconductor switching assembly.

An aspect of a three-phase modular solid-state switching device can include a housing defining three physically isolated phase compartments, a removable switching cartridge disposed within each of the three phase compartments, a bus structure providing electrical connection between the switching cartridges and external high-voltage terminals, and a visible-break mechanical isolation mechanism associated with the housing. Each switching cartridge can include a press-pack semiconductor switching stack, a dielectric sub-chamber, and/or a thermal-management structure. The visible-break mechanical isolation mechanism can be configured to provide a visible isolation gap for at least one of the three phases.

In some embodiments, each switching cartridge can be keyed to a corresponding phase compartment to prevent incorrect phase placement during installation and/or replacement.

In other embodiments, the visible-break mechanical isolation mechanism can include a knife-blade and/or disconnect switch configured to provide a visible air gap for at least one of the three phases when in an open state.

In yet other embodiments, the housing can include molded phase barriers formed from a high-creepage polymer material disposed between adjacent phase compartments.

An aspect of a pole-mounted cylindrical high-voltage solid-state switching device can include an elongated tubular enclosure constructed from a weather-resistant material, a vertically oriented press-pack semiconductor switching stack disposed within a dielectric-filled cavity extending along at least a portion of the tubular enclosure, an upper high-voltage terminal and a lower high-voltage terminal electrically connected to opposite ends of the press-pack semiconductor switching stack, and a pole-mount bracket configured to secure the tubular enclosure to a utility pole and/or crossarm. The vertically oriented press-pack semiconductor switching stack can be aligned substantially along the pole axis.

In some embodiments, the tubular enclosure can include external cooling fins formed along at least a portion of its length to enhance convective heat transfer to ambient air.

In other embodiments, the dielectric-filled cavity within the tubular enclosure can contain an oil-immersed heat exchanger thermally coupled to the press-pack semiconductor switching stack.

In yet other embodiments, the pole-mount bracket can be configured as a dual-arm gallows-type support adapted to withstand wind and/or ice loading consistent with utility design standards.

An aspect of a modular multi-module high-voltage switching rack can include a structural rack frame, a plurality of switching modules mounted to the rack frame, an upper bus-bar assembly, a lower bus-bar assembly, and dielectric partitions. Each switching module can include a press-pack semiconductor switching stack, a dielectric sub-chamber, and/or an associated heat-dissipation structure. The upper and lower bus-bar assemblies can provide electrical interconnection among the plurality of switching modules in at least one of a series configuration, a parallel configuration, and/or a hybrid series-parallel configuration. The dielectric partitions can be disposed between adjacent switching modules and between the switching modules and the rack frame to increase creepage and/or clearance distances.

In some embodiments, the plurality of switching modules can be arranged vertically within the structural rack frame to promote natural convection cooling from bottom to top.

In other embodiments, the structural rack frame can be mounted within an enclosure using shock-absorbing mounts configured to meet seismic design criteria for substation installations.

In yet other embodiments, the upper bus-bar assembly and/or lower bus-bar assembly can include extended creepage surfaces configured to reduce electric field stress in the vicinity of high-voltage connections.

An aspect of a high-voltage solid-state control system for a switching device can include a high-potential gate-drive circuit, an optically isolated communication interface, a sensor suite, and/or a switching controller. The high-potential gate-drive circuit can be disposed within a high-voltage region of an enclosure and can be electrically referenced to the potential of a press-pack semiconductor switching stack. The optically isolated communication interface can couple the high-potential gate-drive circuit to a ground-potential controller. The sensor suite can be disposed proximate to the press-pack semiconductor switching stack and can be configured to measure at least one of current, voltage, phase angle, temperature, and/or harmonic content. The switching controller can be configured to schedule and issue gate-drive commands based at least in part on measured waveform information, including alignment of switching events to current and/or voltage zero-crossings.

In some embodiments, the sensor suite can include at least one current sensor, at least one voltage sensor, and/or at least one temperature sensor affixed to a surface of the press-pack semiconductor switching stack.

In other embodiments, the switching controller can be configured to inhibit switching operations if a measured temperature exceeds a predetermined threshold and/or if measured harmonic distortion exceeds a predetermined limit.

In yet other embodiments, the optically isolated communication interface can be configured to transmit status, event, and/or waveform data to a remote monitoring and/or control center.

An aspect of a bidirectional high-voltage solid-state switching system can include a first semiconductor switching branch, a second semiconductor switching branch, a directional measurement subsystem, and/or a directional control processor. The first semiconductor switching branch can be configured to conduct current in a forward direction. The second semiconductor switching branch can be configured to conduct current in a reverse direction and can be arranged antiparallel to the first semiconductor switching branch. The directional measurement subsystem can be configured to determine at least one of real-power flow direction, reactive-power flow direction, and/or phase-angle relationship between voltage and current. The directional control processor can be configured to selectively enable and/or block switching of at least one of the first semiconductor switching branch and/or the second semiconductor switching branch based on output of the directional measurement subsystem.

In some embodiments, the directional measurement subsystem can utilize phasor measurements derived from synchronized sampling of voltage and/or current waveforms to determine power-flow direction.

In other embodiments, the directional control processor can be configured to block reverse power flow into a designated source bus during fault-isolation and/or islanding-prevention operations.

In yet other embodiments, the bidirectional high-voltage solid-state switching system can be associated with an intertie and/or tie-switch location connecting two distribution feeders and/or substations.

An aspect of a harmonic-mitigation solid-state switching device can include a press-pack semiconductor switching assembly, a harmonic detection processor, a timing controller, and/or a harmonic-mitigation network. The harmonic detection processor can be configured to analyze a power-system waveform and identify one or more harmonic components above a predetermined amplitude threshold. The timing controller can be configured to delay, advance, and/or suppress one or more switching events based on the harmonic components identified by the harmonic detection processor. The harmonic-mitigation network can include at least one of an active snubber circuit, a tuned LC filter, and/or a digital gating algorithm. The harmonic-mitigation network can be configured to reduce at least one of switching losses, electromagnetic interference, and/or waveform distortion during operation in an electric power system.

In some embodiments, the harmonic detection processor can be configured to detect at least one of third, fifth, seventh, eleventh, and/or thirteenth-order harmonic components exceeding a programmed threshold.

In other embodiments, the harmonic-mitigation network can include a digitally controlled snubber circuit whose parameters can be adaptively adjusted based on measured harmonic content.

In yet other embodiments, the timing controller can be configured to avoid executing switching events during identified harmonic peaks to reduce stress on the semiconductor devices and/or connected equipment.

An aspect of a dielectric-segmented high-voltage housing for a solid-state switching assembly can include a plurality of internal dielectric chambers, one or more dielectric walls and/or baffles, and/or a fluid or gas insulating medium. The dielectric chambers can be arranged longitudinally and/or laterally with respect to a press-pack semiconductor switching stack. The dielectric walls and/or baffles can be configured to increase effective creepage and/or clearance distances. The insulating medium can be selected from air, nitrogen, insulating oil, fluorinated dielectric gas, SF₆-free insulating gas, and/or combinations thereof. The dielectric chambers can be configured to enhance insulation performance and permit compact packaging of the solid-state switching assembly.

In some embodiments, at least one dielectric chamber can contain an insulating liquid and at least one other dielectric chamber can contain an insulating gas, the combination being selected to optimize both thermal and/or dielectric performance.

In other embodiments, the dielectric walls and/or baffles can be shaped to increase surface creepage paths and/or reduce localized electric field concentrations near high-voltage conductors.

In yet other embodiments, at least one dielectric chamber can include turbulence-promoting structures configured to enhance convective flow of the insulating medium during thermal loading.

An aspect of an integrated high-voltage solid-state grid-switching device can include a packaged assembly, device, rack, system, and/or housing, and an embedded automation controller. The embedded automation controller can be configured to communicate with at least one of a SCADA system, a distribution automation system, and/or a fault-location, isolation, and service-restoration system. The embedded automation controller can be further configured to execute at least one of automatic feeder transfer, sectionalizing, loop-closing, and/or islanding-prevention operations using the packaged solid-state switching apparatus.

In some embodiments, the embedded automation controller can be configured to execute automatic feeder-transfer sequences in response to a detected loss-of-source condition on a first feeder, by transferring load to a second feeder via the packaged solid-state switching apparatus.

In other embodiments, the embedded automation controller can be configured to coordinate operation of the packaged solid-state switching apparatus with one or more upstream and/or downstream protection devices based on time-current and/or directional protection settings.

In yet other embodiments, the embedded automation controller can be configured to participate in a fault-location, isolation, and service-restoration scheme that can automatically isolate faulted sections and/or restore service to unfaulted sections using the packaged solid-state switching apparatus.

### BRIEF DESCRIPTION OF THE DRAWINGS

A modular high-voltage switching system, of the present disclosure will now be described with the help of the accompanying drawing, in which:

FIG. 1 illustrates a control system architecture of a modular high-voltage switching system, in accordance with an embodiment of the present disclosure;

FIG. 2 illustrates a press-pack module assembly of a modular high-voltage switching system, in accordance with an embodiment of the present disclosure;

FIG. 3 illustrates a multi-module assembly pack of a modular high-voltage switching system, in accordance with an embodiment of the present disclosure;

FIG. 4 illustrates an enclosure of a modular high-voltage switching system, in accordance with an embodiment of the present disclosure;

FIG. 4a illustrates a bisection of an enclosure of a modular high-voltage switching system, in accordance with an embodiment of the present disclosure;

FIG. 5 illustrates a pole mount switch example of a modular high-voltage switching system, in accordance with an embodiment of the present disclosure;

FIG. 6 illustrates a bidirectional switching module pack configuration of a modular high-voltage switching system, in accordance with an embodiment of the present disclosure;

FIG. 7 illustrates an in-phase voltage and current switching profile of a modular high-voltage switching system, in accordance with an embodiment of the present disclosure;

FIG. 8 illustrates an out-of-phase voltage and current switching profile of a modular high-voltage switching system, in accordance with an embodiment of the present disclosure; and

FIG. 9 illustrates a zero-crossing versus non-zero-crossing switching output profile of a modular high-voltage switching system, in accordance with an embodiment of the present disclosure.

FIG. 10 illustrates a harmonic detection module with timing controller and adaptive snubber circuitry.

FIG. 11 illustrates a visible-break isolation mechanism with knife-blade disconnects and manual operating handle.

FIG. 12 illustrates a modular rack assembly with dielectric partitions, seismic mounts, and convection cooling architecture.

### DETAILED DESCRIPTION

The terminology used, in the present disclosure, is only for the purpose of explaining a particular embodiment and such terminology shall not be considered to limit the scope of the present disclosure. As used in the present disclosure, the forms “a,” “an,” and “the” can be intended to include the plural forms as well, unless the context clearly suggests otherwise. The terms “comprises,” “comprising,” “including,” and “having” are open-ended transitional phrases and therefore specify the presence of stated features, integers, steps, operations, elements, and/or components, but do not forbid the presence or addition of one or more other features, integers, steps, operations, elements, components, and/or groups thereof.

When an element is referred to as being “mounted on,” “engaged to,” “connected to,” or “coupled to” another element, it can be directly on, engaged, connected, or coupled to the other element. As used herein, the term “and/or” includes any and all combinations of one or more of the associated listed elements.

A modular high-voltage switching system is described in detail with reference to FIG. 1 through FIG. 9. The preferred embodiment does not limit the scope and ambit of the claims presented herein. Embodiments are provided so as to thoroughly and fully convey the scope of the present disclosure to the person skilled in the art. Numerous details are set forth, relating to specific components, and methods, to provide a complete understanding of embodiments of the present disclosure. It will be apparent to the person skilled in the art that the details provided in the embodiments should not be construed to limit the scope of the present disclosure. In some embodiments, well-known apparatus structures, and well-known techniques are not described in detail.

Traditional mechanical switches and circuit breakers rely on physical components, leading to slow response times that hinder timely fault isolation and load transfer. While solid-state solutions like thyristors offer some improvement, their slower turn-off times and reliance on auxiliary circuits make them less ideal for modern, dynamic power grids. Additionally, the mechanical wear from arcing in conventional systems causes significant degradation over time, increasing maintenance needs, and operational costs, and reducing lifespan.

Another pressing issue is the absence of zero-crossing switching in traditional systems, which results in electrical transients, noise, and stress on downstream equipment. Furthermore, these systems are often rigid in design, lacking modularity and adaptability to varying voltage classes and load demands. This rigidity necessitates the deployment of multiple device types, complicating system design and increasing costs. Environmental susceptibility further exacerbates these challenges, as many existing solutions fail to protect against harsh conditions like temperature extremes, moisture, and contaminants, leading to premature failures in exposed installations.

Beyond these limitations, conventional systems often lack integrated fault management, relying on external devices for fault detection and isolation. This introduces delays and heightens the risk of widespread outages, undermining grid resilience. Energy inefficiency is another concern, with significant electrical losses during switching and an inability to optimize switching points. These deficiencies contribute to system instability and persistent energy wastage, underscoring the need for innovative, scalable, and adaptable switching technologies that address the demands of modern utility networks.

There is, therefore, a need to provide a modular IGBT-based switching system that overcomes these limitations, offering faster switching, reduced maintenance, environmental resilience, and enhanced fault management capabilities to alleviate the aforementioned disadvantages.

Some of the objects of the present disclosure, which at least one embodiment herein satisfies, are as follows. An object of the present disclosure is to provide a modular high-voltage switching system. Another object of the present disclosure is to design a modular high-voltage switching system to manage medium-voltage to high-voltage AC (alternate current) systems, making it suitable for a wide range of distribution network applications. Another object of the present disclosure is to provide a modular high-voltage switching system that ensures robust insulation and reliable voltage handling across various voltage classes. Another object of the present disclosure is to provide a press pack design that ensures consistent performance under high-voltage and high-current conditions. Another object of the present disclosure is to provide a modular high-voltage switching system that protects the system from environmental factors, ensuring reliable outdoor performance. Other objects and advantages of the present disclosure will be more apparent from the following description, which is not intended to limit the scope of the present disclosure.

An advanced power control system can utilizing press-pack IGBTs (Insulated Gate Bipolar Transistors), IGCTs (Integrated Gate Commutated Thyristors), or fast-switching thyristors. A system can be designed to manage bidirectional power flow through an innovative configuration of IGBT connections, enabling efficient and reliable control of electrical power in high-voltage applications. A key aspect can include mechanical packaging, which can ensure even pressure distribution on the press packs, coupled with thermally and electrically conductive materials for passive cooling. Each IGBT press pack can include a control circuit that operates at the same voltage potential as the device to prevent arcing. The system can also feature optical connections for controlling the optoisolator and managing AC signal phases.

The system can include a robust mechanical frame with a protective cover and silicone over-mold for hermetic sealing, compliant with IEEE standards for electrical insulation and creepage distances. The design also incorporates a modular switch assembly that can be mounted on various apparatuses like poles, pad mounts, or bus bars, featuring a mechanical bypass switch for secure disconnection from the power grid. Reliability is enhanced through the use of parallel IGBT devices, ensuring continuous operation even in the event of a device failure. A master control circuit synchronizes the operation of the IGBT devices, enabling precise switching and real-time fault detection, with communication capabilities to integrate seamlessly with utility SCADA systems. This disclosure provides significant advancements over existing technologies by offering a scalable, reliable, and efficient power control system suitable for high-voltage applications, with modular components that allow for easy maintenance and integration into existing power distribution infrastructure.

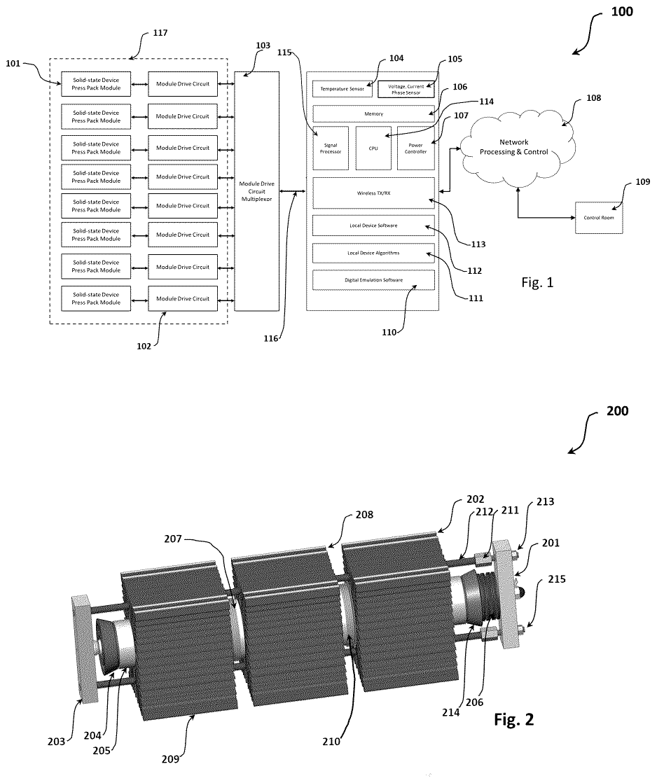

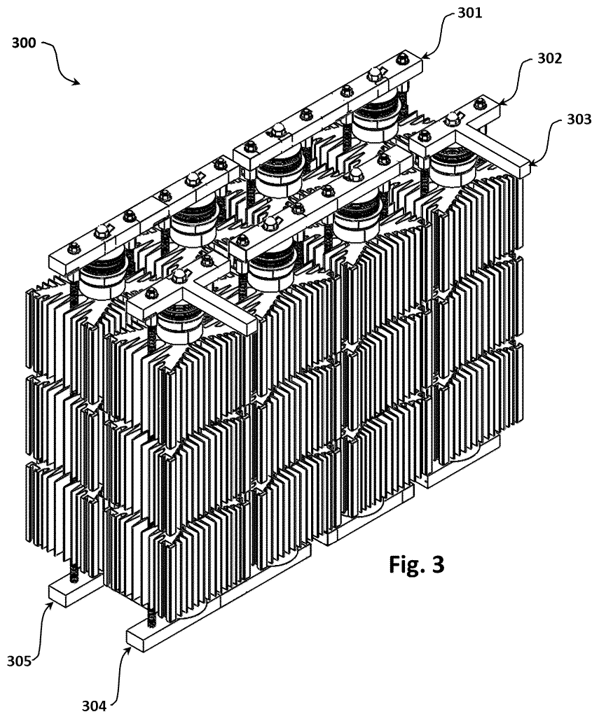

The architecture of a control system (100) is depicted in FIG. 1, which shows the core elements that coordinate the operation of the press-pack IGBT (101) assemblies illustrated in FIG. 2 and the press-pack module drive circuit (102). At the core of the system (100) is the press-pack module drive circuit (102), which provides control signals to multiple press-pack devices. These control signals are synchronized to ensure simultaneous and precise switching operations across all connected modules. The system (100) includes a signal multiplexer (103) that enables individual control of each press-pack device, allowing for fine-tuned operation and enhanced adaptability. A temperature sensor (104) monitors the thermal conditions of the press-pack assemblies, ensuring that the devices remain within their optimal operating temperature range. The system (100) integrates voltage, current, and phase sensors (105) to measure real-time parameters such as phase angle, voltage level, and current. These measurements are essential for implementing advanced switching techniques like zero-crossing switching, which minimizes electrical noise and arcing. The data collected is processed and stored in a device storage memory (106), enabling historical data analysis and fault diagnostics. Finally, an input power control device (107) ensures the appropriate power supply to the system (100), adapting to the varying load and operational requirements. It also connects to external systems via a network connection (108) and integrates with a utility control software (109), providing seamless interoperability with SCADA systems. A digital emulation software module (110) can simulate various operating conditions to optimize performance and validate configurations before deployment. For enhanced operational flexibility, the system includes a locally run software (112) and device algorithms (111), which enable on-site adjustments and adaptive responses to grid conditions. The system (100) supports remote communication and monitoring through a wireless transmitter and receiver (113), which can send and receive data from utility control centers or remote operators. The system's (100) central processing unit (CPU, 114) acts as the operational hub, coordinating all components and managing switching logic. It interacts with a digital-to-analog and analog-to-digital processor (115) to convert signals for compatibility between analog sensors and digital control systems through a control signal connection (116). To isolate the control circuitry from high-voltage components, an optical or electrical isolation mechanism (117) is implemented, safeguarding the control electronics from potential high-voltage interference. This control system (100), as depicted in FIG. 1, provides a comprehensive framework for managing high-voltage switching operations with precision, reliability, and adaptability.

In FIG. 2, a press-pack module assembly (200) is shown. The press-pack module assembly (200) forms the core switching component of the high-voltage system. This assembly is designed to house press-pack IGBT modules (101) and ensure their stable operation under demanding conditions in medium-to high-voltage applications. The assembly (200) incorporates a mechanical holding plate (201, 203) that secures the press-pack modules and provides a high-voltage connection point. This plate ensures the structural stability of the assembly, enabling it to withstand mechanical and thermal stresses during operation. To ensure consistent pressure across the press-pack modules, a press cone (204) and a pressure mounting plate (205) are used. These components distribute mechanical force evenly across the modules, preventing localized stress that could lead to electrical contact failure or thermal degradation. To account for thermal expansion caused by temperature fluctuations, spring mechanisms (206) are integrated into the design. These springs maintain consistent pressure on the press-pack modules, preventing mechanical instability under varying thermal conditions. Press-pack modules (207, 210, 200, 101), which consist of IGBT or thyristor devices, are configured in series for high-voltage applications or in parallel for high-current demands, depending on the operational requirements. Each press-pack module is designed for optimal electrical and thermal performance. The assembly includes heat sinks (208, 209, and 202) attached to the press-pack modules to dissipate heat generated during operation. These heat sinks are critical for maintaining the thermal stability of the system and extending the lifespan of the press-pack devices. The components are held together by a mechanical mounting rod (212), secured with mounting bolts (211) and retaining nuts (213, 215). This robust construction ensures that the press-pack modules remain securely fastened and aligned, even under high operational loads. A pressure distribution cone (214) further ensures that the force applied to the modules is evenly spread across the entire assembly, enhancing reliability during operation. The design of the press-pack module assembly (200), as shown in FIG. 2, provides a reliable, modular solution for high-voltage switching applications. It combines mechanical robustness, thermal efficiency, and electrical reliability to meet the demands of modern utility networks.

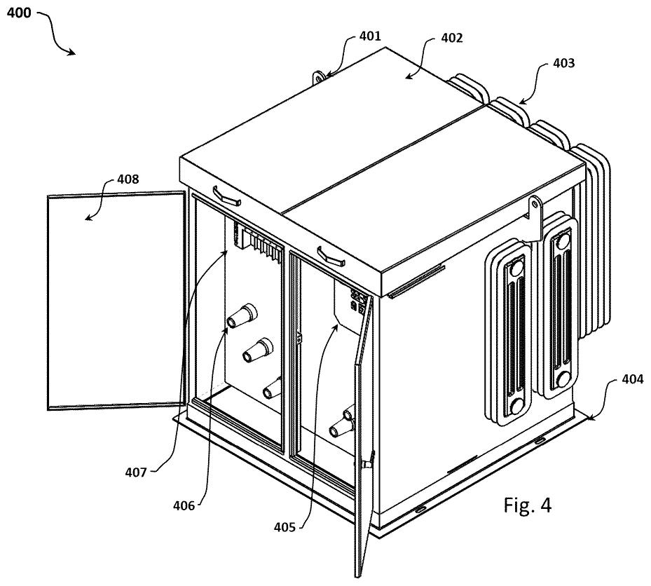

In FIG. 3, a multi-module assembly pack (300) is shown. The multi-module assembly pack (300) is designed for high-voltage applications such as 27 kV systems. This modular assembly is a critical component of the switching system, enabling scalable configurations to meet varying voltage and current demands in utility networks. A top bus bar assembly (301) and bus bar output assembly (302) is integral to the design, providing robust and reliable pathways for current distribution across the assembly. These bus bars are engineered to handle the high electrical loads typical of medium- and high-voltage applications. The assembly includes electrical connection points (303) that facilitate seamless integration with external grid systems or additional modules. These connections are designed to maintain electrical stability and ensure minimal resistance, optimizing the flow of electricity within the network. At the lower section of the assembly, bottom bus bar connections (304, 305) complete the electrical pathways, ensuring consistent current distribution across all interconnected modules. These components are securely mounted and electrically insulated to prevent arcing or energy losses during operation. The modular nature of the assembly allows for easy scalability. This adaptability makes the multi-module assembly pack (300) highly suitable for diverse grid applications, enabling efficient power management and fault isolation in utility networks. The design of the assembly also incorporates mechanical and thermal stability features. The bus bars and connection points are robustly constructed to endure mechanical stresses and thermal expansion caused by high-current operations. This ensures reliable and long-lasting performance, even under demanding conditions. In an embodiment, FIG. 3 demonstrates a versatile and modular assembly that enhances the scalability, reliability, and operational efficiency of the high-voltage switching system. Its design supports the dynamic requirements of modern utility grids, providing an adaptable solution for high-power applications.

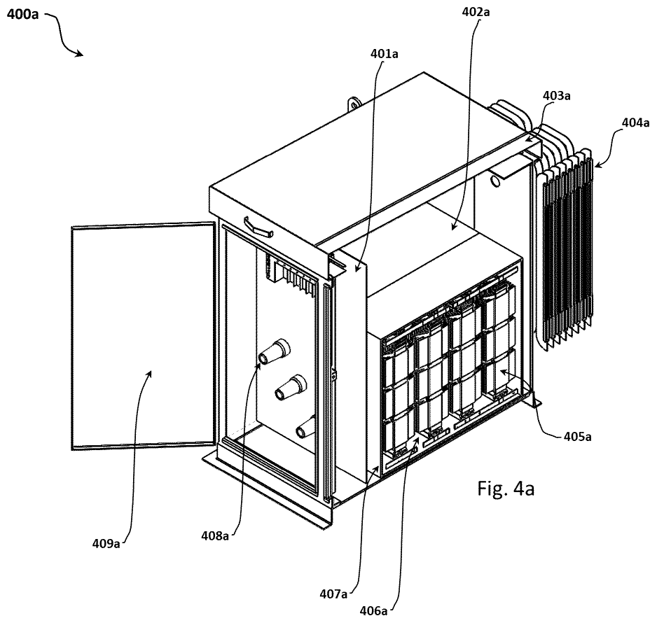

In FIG. 4, an enclosure (400) for the high-voltage switching system is shown. The enclosure (400) is system is designed to protect internal components, provide thermal management, and ensure safety and compliance with electrical standards in medium- to high-voltage applications. The enclosure is equipped with lifting hooks (401) to facilitate safe and efficient transportation and installation of the system. These hooks are robustly designed to support the weight of the enclosure and its internal components during handling and placement. Access panels (402) are included to enable easy maintenance and inspection of the internal components without requiring the disassembly of the entire enclosure. These panels are strategically located to provide convenient access to critical parts of the system. For effective thermal management, the enclosure incorporates cooling radiators (403), which dissipate heat generated during operation. These radiators maintain optimal operating temperatures for the press-pack modules and other internal components, ensuring consistent performance and prolonging their lifespan. A mounting flange (404) is designed to securely anchor the enclosure to its installation site, whether on a pad, pole, or other mounting configuration. This feature ensures stability and safety during operation, even under external mechanical stresses. Control electronics (405) and sensor electronics (406) are housed within the enclosure, providing the necessary systems for monitoring and controlling the press-pack IGBT modules. In an embodiment, the control electronics (405) and the sensor electronics (406) consist of the core elements that coordinate the operation of the press-pack IGBT (101) assemblies as shown in FIG. 1. These electronics are shielded from environmental contaminants, ensuring reliable operation under diverse conditions. Electrical connection points (407) facilitate the integration of the enclosure with the utility grid, enabling efficient power flow and seamless interaction with other components of the distribution network. These connection points are designed for high-voltage applications, ensuring secure and stable electrical interfaces. An enclosure door (408) provides an additional layer of protection and access to the interior. The enclosure door (408) is constructed to seal effectively, preventing the ingress of dust, moisture, and other contaminants while still allowing maintenance personnel to access the internal components when required. In an embodiment, FIG. 4 demonstrates a robust and carefully designed enclosure that combines safety, accessibility, and thermal management. This enclosure plays a vital role in protecting the high-voltage switching system while ensuring its reliable operation in various utility environments.

In FIG. 4a, a bisection of an enclosure (400a) for a three-phase 27 kV device is shown. The bisection of an enclosure (400a) for a three-phase 27 kV device provides an example of the internal configuration and structural elements necessary for efficient operation and thermal management in high-voltage applications. The enclosure is designed to house, protect, and optimize the performance of press-pack module assemblies and associated components. The enclosure features a front separation panel (401a) that divides and organizes the internal compartments, ensuring physical and electrical separation of components for enhanced safety and reliability. This panel prevents unintended interactions between the phases, maintaining operational integrity. The cooling requirements are addressed by a cooling chamber (402a) that is filled with either oil or air, depending on the thermal management needs of the system. The cooling chamber dissipates heat generated during high-power switching operations, ensuring that the press-pack modules remain within their operational temperature range. A bisection line (403a) defines the division within the enclosure, marking the separation of the internal sections for clarity and structural organization. Heat dissipation is further enhanced by a bisection of the radiator (404a), which splits the cooling radiators into sections for efficient thermal management across the three phases. This design allows heat to be evacuated evenly from all phases, reducing the risk of thermal hotspots and enhancing the durability of the system components. The press-pack module assembly (405a, 200) is secured within the enclosure to ensure consistent electrical and thermal performance, supported by structural and thermal isolation mechanisms. The enclosure also incorporates an inner cooling chamber and electrical isolation (406a), which provides an additional layer of safety by electrically isolating the press-pack assemblies from the external environment. This chamber can be air-or oil-filled, depending on the insulation and cooling requirements, ensuring reliable operation even under harsh conditions. The system is modularized into a complete assembly for one phase (407a), allowing easy installation, maintenance, and replacement of individual phase modules without disrupting the entire system. The modularity improves system flexibility and reduces downtime during maintenance. Electrical connections are made through dedicated electrical connection points (408a), which ensure secure and reliable interfaces for integrating the press-pack assemblies with external circuits or grids. These connections are designed to handle high voltages and currents typical of 27 kV systems. The enclosure includes an access door (409a) to provide safe and convenient entry for maintenance personnel. This door is designed to seal the enclosure effectively, protecting internal components from environmental contaminants such as dust, moisture, and debris while ensuring easy access when needed. In an embodiment, FIG. 4a demonstrates an advanced enclosure design tailored for high-voltage three-phase applications, integrating robust cooling, modularity, and safety features. These elements collectively enhance the system's efficiency, reliability, and ease of operation in demanding utility environments.

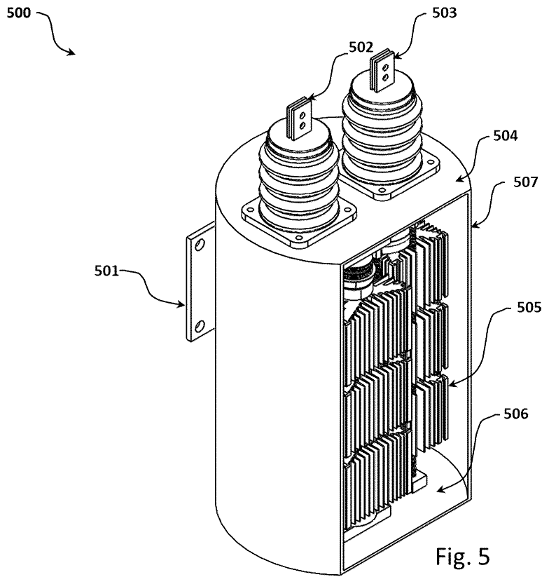

Now as shown in FIG. 5, a pole-mount switch configuration (500) is specifically adapted for 15 kV utility networks. This configuration includes a mounting bracket (501) to secure the switch assembly (500) to poles or other field installations. The press-pack module assembly (506, 405a, 200) is housed within a cross section (505) of a weather-resistant enclosure tube (504). The inclusion of cooling chambers and electrical isolation (507) provides safe and stable operation, even in outdoor settings, where temperature fluctuations and environmental exposure are expected. Electrical input and output connections (502, 503) provide secure interfaces for integration with the utility grid.

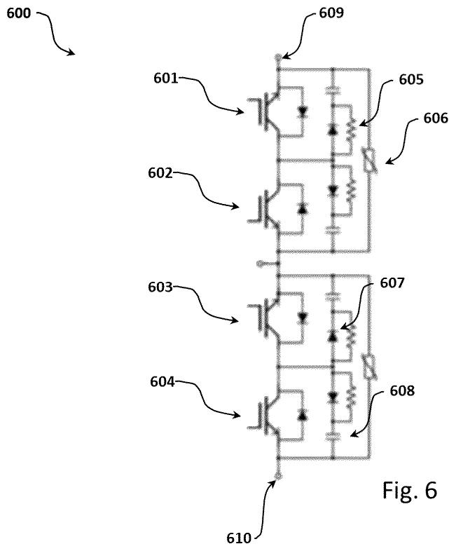

As shown in FIG. 6, a bidirectional switching module pack (600) enables current flow in both source-to-load and load-to-source directions. The press-pack IGBT modules (601, 602, 603, 604, 506, 405a, 210, 207, 200, 101) are arranged to support this bidirectional current flow, which is crucial for intertie operations and load balancing across distribution networks. Circuit stabilizing components, including resistors (605), snubber circuits (606), diodes (607), and capacitors (608), protect against voltage surges and transients, ensuring stable and reliable circuit operation. Electrical connection points (609) and (610) integrate the bidirectional module pack with utility systems, adding versatility to the system's applications.

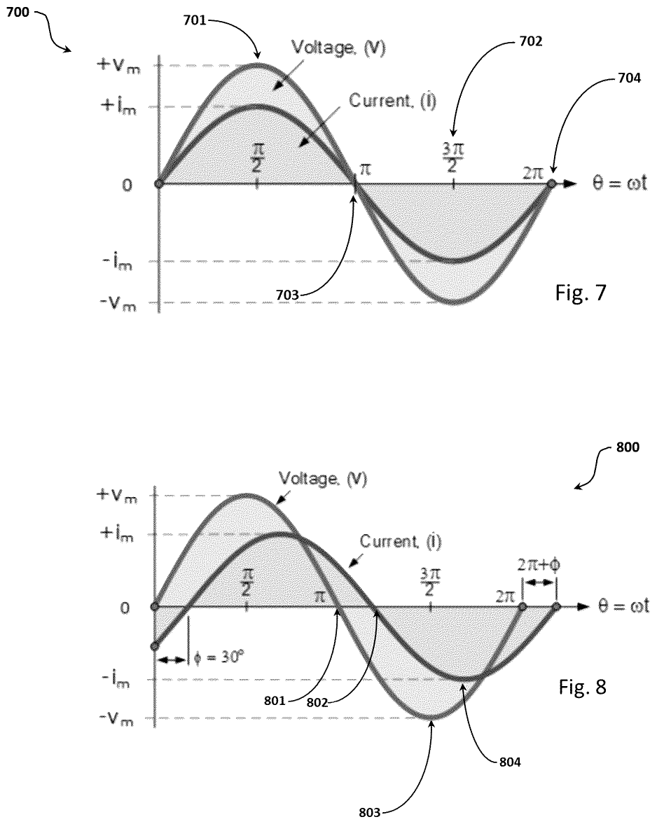

Now as shown in FIG. 7, an in-phase voltage and current switching profile (700) for the high-voltage switching system is focusing on the identification of optimal and non-optimal switching points within the AC waveform. This profile highlights the significance of precise timing in switching operations to minimize wear and enhance system efficiency. A non-optimal voltage and current switching points (701, 702) occur when the voltage and/or current are at higher levels during the switching operation. Switching at these points can result in increased arcing, electrical noise, and thermal stress on the switching components. This not only accelerates the wear of the press-pack modules but can also lead to inefficiencies and potential instability in the power distribution system. In contrast, an optimal voltage and current switching points (703, 704) represent instances where both the voltage and current are at or near their minimum values in the AC waveform. Switching at these points significantly reduces arcing and electrical noise, ensuring smoother transitions and prolonging the lifespan of the press-pack IGBT modules. These points are critical for achieving zero-crossing switching, which is a key feature of the system. The data provided by the sensors (referenced in FIG. 1) for voltage, current, and phase angle is processed by the system's central processing unit (CPU, referenced in FIG. 1, 114). This enables the switching system to identify and operate precisely at the optimal points (703, 704) while avoiding the non-optimal points (701, 702). This in-phase switching profile, as depicted in FIG. 7, underpins the system's ability to perform zero-crossing switching. By leveraging this profile, the system ensures efficient, reliable, and long-lasting operation in medium-to high-voltage utility applications. This approach reduces maintenance needs and enhances the overall stability of the electrical grid.

As illustrated in FIG. 8, an out-of-phase voltage and current switching profile (800) demonstrates the behavior of the high-voltage switching system during switching operations that occur when the voltage and current are not aligned. This profile is critical for understanding the importance of timing in high-voltage switching to avoid inefficiencies and potential damage to system components. An optimal voltage switching point (801) and an optimal current switching point (802) are highlighted within the waveform. These points indicate moments when either the voltage or current is at its minimum, making them favorable for switching operations. Selecting these optimal points helps to reduce arcing and electrical noise, ensuring smooth and efficient transitions. Conversely, a non-optimal voltage switching point (803) and a non-optimal current switching point (804) represent moments when voltage or current is at higher levels. Switching at these points can lead to increased thermal stress, higher energy losses, and elevated wear on the press-pack modules. Over time, this can reduce the lifespan of the switching components and increase maintenance requirements. The out-of-phase switching profile emphasizes the challenges of aligning voltage and current during switching operations. The system's integrated sensors (referenced in FIG. 1, 105) continuously monitor real-time voltage, current, and phase data. This information is processed by the central processing unit (CPU, referenced in FIG. 1, 114) to ensure that switching occurs at the most optimal points (801, 802), avoiding the risks associated with non-optimal points (803, 804). By leveraging the insights provided by the out-of-phase profile, the switching system can perform precise and reliable switching operations even under complex grid conditions. This capability enhances the efficiency, reliability, and safety of the system in medium- to high-voltage applications, supporting modern utility network requirements.

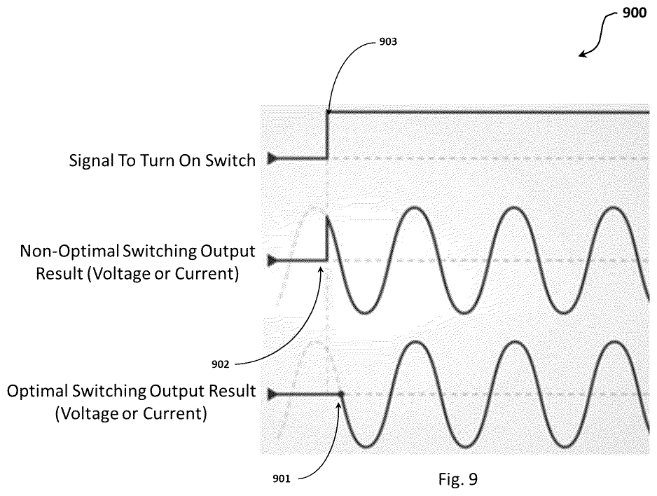

As illustrated in FIG. 9, a zero-crossing versus non-zero-crossing switching output profile (900) for the high-voltage switching system underscores the operational advantages of performing switching at zero-crossing points in the AC waveform and the associated drawbacks of switching at non-zero-crossing points. A non-optimal switching output result (901) occurs when switching is performed at non-zero points in the waveform, where voltage and/or current are at higher levels. This results in significant arcing, elevated electrical noise, and increased thermal stress, which can accelerate wear on the switching components. The inefficiencies caused by non-optimal switching can also lead to higher energy losses and potential disruptions in grid performance. An optimal switching output result (902) demonstrates the benefits of zero-crossing switching, where both voltage and current are near or at zero. At these points, switching operations generate minimal arcing and electrical noise, leading to reduced thermal stress on the press-pack IGBT modules and increased overall efficiency. Zero-crossing switching also mitigates the risks of transient disturbances, which can affect the stability of the electrical grid and downstream equipment. The system achieves zero-crossing switching through precise timing managed by a control signal (903) generated by the press-pack module drive circuit (referenced in FIG. 1, 102). The sensors (referenced in FIG. 1, 105) continuously monitor real-time voltage, current, and phase data, which is processed by the central processing unit (CPU, referenced in FIG. 1, 114) to ensure that switching occurs only at optimal points. This zero-crossing versus non-zero-crossing profile highlights the technological advancements of the system, which include improved efficiency, reduced component wear, and enhanced reliability. By ensuring that switching operations are performed at zero-crossing points, the system meets the demanding requirements of modern utility networks, supporting stable and efficient high-voltage power distribution.

In various embodiments, a switching apparatus can include a modular press-pack stack, dielectric insulation chambers, thermal management structures, high-voltage bushings, automation and control subsystems, and mechanical support assemblies. The apparatus can be configured for installation in pad-mounted, pole-mounted, or rack-mounted arrangements, and can be adapted to operate in distribution networks at nominal system voltages of 15 kV, 27 kV, or other suitable ratings.

In certain embodiments, the apparatus includes a dielectric insulation chamber configured to contain one or more insulating media selected from air, nitrogen, insulating oil, fluorinated dielectric gas, and SF₆-free gas mixtures. The chamber can be hermetically sealed to prevent ingress of moisture or contaminants, and can be pressurized above atmospheric pressure, for example between approximately 1.2 and 2.5 bar, to increase dielectric strength. Pressure monitoring devices, including electronic sensors and mechanical relief valves, can be integrated to provide overpressure protection and enable remote condition monitoring.

In some embodiments, the housing can be segmented into multiple dielectric chambers separated by dielectric walls or baffles. One chamber may contain a liquid dielectric medium, while another chamber contains a gaseous dielectric medium. Turbulence-promoting structures can be disposed within each chamber to enhance convective cooling and maintain uniform temperature distribution. Mixed-media dielectric configurations can be employed to optimize both thermal performance and insulation capability.

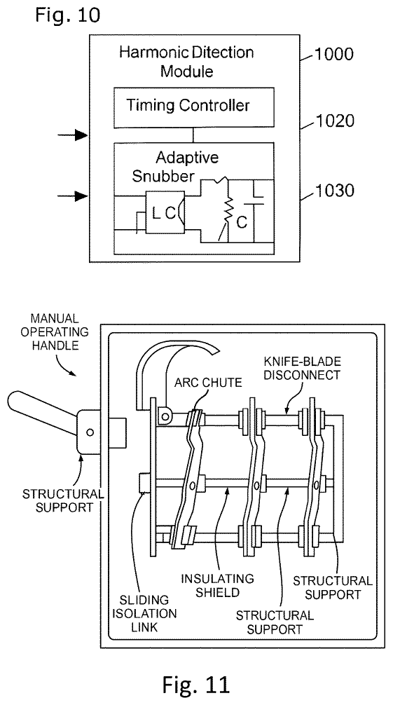

As illustrated in FIG. 10, the harmonic detection module may perform synchronized waveform sampling of line voltage and current at a rate sufficient to detect harmonic orders. The timing controller adjusts switching events to avoid coinciding with harmonic peaks, thereby reducing stress on semiconductor devices. An adaptive snubber circuit includes parallel-connected LC filter components tuned to attenuate specific harmonic frequencies and minimize electromagnetic interference (EMI). The module may further comprise a harmonic distortion threshold comparator that inhibits gating signals when distortion exceeds a preprogrammed limit, thereby preventing operation under adverse power quality conditions.

Referring to FIG. 11, a visible-break isolation mechanism can be implemented using knife-blade disconnect elements or sliding isolation links, each configured to create a visible air gap when in the open position. The mechanism can be mounted within a three-phase enclosure meeting applicable utility safety standards, such as ANSI C37. The manual operating handle can be lockable in the open position to prevent inadvertent closure. Structural supports maintain alignment and specified clearance distances to meet creepage and strike requirements. In certain embodiments, the isolation mechanism incorporates arc chutes or insulating shields to enhance operator safety.

The press-pack stack and associated thermal management structures can be dimensioned to carry at least 600 amperes of line current at nominal system frequencies of 50 Hz or 60 Hz. Heat sinks, external fins, and convection channels are sized to maintain semiconductor junction temperatures below approximately 125° C. under full-rated load conditions. In certain embodiments, oil-immersed heat exchangers or forced-air blowers are employed to further improve heat dissipation.

Pole-mounted cylindrical embodiments may incorporate axial convection channels and external fins to increase surface area for heat dissipation. An internal oil-immersed heat exchanger can be used to improve thermal performance. Gallows-type brackets can be employed to secure the device to a pole, with mechanical strength sufficient to withstand wind and ice loads in accordance with applicable utility structural standards.

Enclosures can be fabricated from powder-coated aluminum, stainless steel, or glass-fiber reinforced polymer to provide mechanical strength and corrosion resistance. Access doors may include gasketed seals to achieve ingress protection ratings of IP65 or higher, preventing dust and water intrusion. Certain embodiments include a pad-mount base plate with bolting holes and lifting lugs for ease of installation. A removable, hermetically sealed internal tank housing the press-pack assembly can be provided to facilitate replacement without disturbing the external enclosure.

Field-deployable units may incorporate high-voltage bushings rated for 15 kV or 27 kV, suitable for connection to either overhead or underground conductors. The bushings may include polymeric sheds dimensioned to meet creepage distance requirements under pollution severity classifications per IEC 60815. The bushings can be mounted directly to the enclosure or to an internal dielectric barrier to maintain required strike distances.

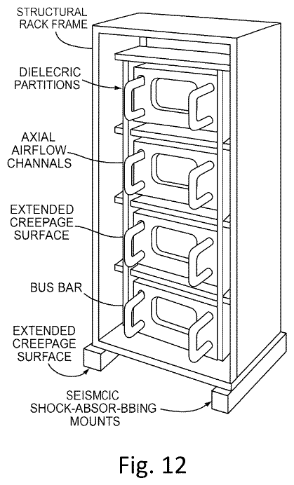

As shown in FIG. 12, the modular rack assembly may include a structural rack frame supporting multiple switching modules. Dielectric partitions between modules increase creepage distances and reduce electric field stress. The rack is arranged vertically to promote natural convection cooling through axial airflow channels. Seismic shock-absorbing mounts at the base comply with regional seismic design criteria, enabling installation in high-risk zones. Bus bars feature extended creepage surfaces and rounded edges to minimize corona discharge. The modular architecture facilitates maintenance by allowing removal and replacement of individual modules without disturbing adjacent units.

An embedded controller may execute automation sequences including feeder transfer, sectionalizing, loop-closing, and islanding prevention. The controller may implement a programmed state machine that, upon detecting loss-of-source on a feeder, opens the affected switch, verifies absence of voltage, and closes a tie switch to an alternate feeder within approximately 500 milliseconds. Fault location, isolation, and service restoration (FLISR) logic segments the network to isolate faulted portions and restore service to non-faulted segments autonomously.

A directional measurement subsystem may use synchronized sampling of voltage and current waveforms to compute real and reactive power flow. A directional control processor can inhibit reverse power flow into a source bus during islanding prevention or intertie operations, thereby maintaining system stability. The subsystem may operate in coordination with the automation logic to ensure compliance with grid interconnection requirements.

Sensors for voltage, current, temperature, and harmonic distortion can be affixed directly to the press-pack surfaces or associated bus work. The controller may inhibit switching operations if measured temperature exceeds a threshold, or if harmonic distortion surpasses preprogrammed limits, thereby protecting equipment and maintaining power quality. Sensor data can be logged and transmitted via a communication interface for predictive maintenance purposes.

The foregoing description of the embodiments has been provided for purposes of illustration and is not intended to limit the scope of the present disclosure. Individual components of a particular embodiment are generally not limited to that particular embodiment, but, are interchangeable. Such variations are not to be regarded as a departure from the present disclosure, and all such modifications are considered to be within the scope of the present disclosure.

The embodiments herein and the various features and advantageous details thereof are explained with reference to the non-limiting embodiments in the following description. Descriptions of well-known components and processing techniques are omitted so as to not unnecessarily obscure the embodiments herein. The examples used herein are intended merely to facilitate an understanding of ways in which the embodiments herein can be practiced and to further enable those of skill in the art to practice the embodiments herein. Accordingly, the examples should not be construed as limiting the scope of the embodiments herein.

The foregoing description of the specific embodiments so fully reveals the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

The use of the expression “at least” or “at least one” suggests the use of one or more elements or ingredients or quantities, as the use can be in the embodiment of the disclosure to achieve one or more of the desired objects or results.

Any discussion of documents, acts, materials, devices, articles, or the like that has been included in this specification is solely for the purpose of providing a context for the disclosure. It is not to be taken as an admission that any or all of these matters form a part of the prior art base or were common general knowledge in the field relevant to the disclosure as it existed anywhere before the priority date of this application.

The numerical values mentioned for the various physical parameters, dimensions, or quantities are only approximations and it is envisaged that the values higher/lower than the numerical values assigned to the parameters, dimensions or quantities fall within the scope of the disclosure, unless there is a statement in the specification specific to the contrary.

While considerable emphasis has been placed herein on the components and component parts of the preferred embodiments, it will be appreciated that many embodiments can be made and that many changes can be made in the preferred embodiments without departing from the principles of the disclosure. These and other changes in the preferred embodiment as well as other embodiments of the disclosure will be apparent to those skilled in the art from the disclosure herein, whereby it is to be distinctly understood that the foregoing descriptive matter is to be interpreted merely as illustrative of the disclosure and not as a limitation.

We claim:

1. A high-voltage solid-state switching assembly for use in an electric power transmission, subtransmission, or distribution network, the assembly comprising:
a press-pack semiconductor switching stack including a plurality of solid-state switching devices connected in series;
a pressure-distribution mechanism including a pressure cone, compression plate, and spring system configured to maintain substantially uniform contact pressure across the press-pack semiconductor switching stack during thermal and electrical cycling;
a dielectric insulation chamber containing an insulating medium selected from air, nitrogen, insulating oil, fluorinated dielectric gas, SF₆-free insulating gas, and a combination thereof, the dielectric insulation chamber being dimensioned to provide required creepage and clearance distances for the intended system voltage; and
a thermal-management arrangement including at least one of a heat sink, external fin, radiator plate, and convection-promoting channel configured to dissipate heat generated by the press-pack semiconductor switching stack during operation.

2. The high-voltage solid-state switching assembly of claim 1, wherein the press-pack semiconductor switching stack comprises insulated-gate bipolar transistors (IGBTs), integrated gate-commutated thyristors (IGCTs), fast recovery diodes, or a combination thereof rated for at least a 15 kV distribution-class application.

3. The high-voltage solid-state switching assembly of claim 1, wherein the insulating medium within the dielectric insulation chamber is maintained at a pressure above atmospheric pressure to increase dielectric withstand strength.

4. The high-voltage solid-state switching assembly of claim 1, wherein the thermal-management arrangement is configured to dissipate heat generated during interruption or conduction of at least 600 A of line current at a nominal system frequency of 50 Hz or 60 Hz.

5. A field-deployable high-voltage solid-state switching device comprising:
a corrosion-resistant enclosure sealed against moisture and environmental contaminants;
a dielectric-filled internal compartment containing a press-pack semiconductor switching assembly;
at least one high-voltage bushing or terminal configured for direct connection to an overhead or underground power conductor; and
a mounting interface configured for attachment to at least one of a utility pole, a pad-mount foundation, a vault structure, or a substation rack, thereby enabling deployment of the device in transmission, subtransmission, or distribution networks.

6. The field-deployable high-voltage solid-state switching device of claim 5, wherein the corrosion-resistant enclosure comprises at least one of powder-coated aluminum, stainless steel, and glass-fiber-reinforced polymer, and includes a gasketed access door for field maintenance of the press-pack semiconductor switching assembly.

7. The field-deployable high-voltage solid-state switching device of claim 5, wherein the mounting interface includes a base plate configured for bolting to a pad-mount foundation, and further comprises lifting lugs for hoisting the enclosure during installation and removal.

8. The field-deployable high-voltage solid-state switching device of claim 5, wherein the dielectric-filled internal compartment comprises a removable internal tank that is hermetically sealed and replaceable as a unit containing the press-pack semiconductor switching assembly.

9. A three-phase modular solid-state switching device comprising:
a housing defining three physically isolated phase compartments;
a removable switching cartridge disposed within each of the three phase compartments, each switching cartridge including a press-pack semiconductor switching stack,
a dielectric sub-chamber, and a thermal-management structure;
a bus structure providing electrical connection between the switching cartridges and external high-voltage terminals; and
a visible-break mechanical isolation mechanism associated with the housing and configured to provide a visible isolation gap for at least one of the three phases.

10. The three-phase modular solid-state switching device of claim 9, wherein each switching cartridge is keyed to a corresponding phase compartment to prevent incorrect phase placement during installation or replacement.

11. The three-phase modular solid-state switching device of claim 9, wherein the visible-break mechanical isolation mechanism comprises a knife-blade or disconnect switch configured to provide a visible air gap for at least one of the three phases when in an open state.

12. The three-phase modular solid-state switching device of claim 9, wherein the housing further comprises molded phase barriers formed from a high-creepage polymer material disposed between adjacent phase compartments.

13. A pole-mounted cylindrical high-voltage solid-state switching device comprising:
an elongated tubular enclosure constructed from a weather-resistant material;
a vertically oriented press-pack semiconductor switching stack disposed within a dielectric-filled cavity extending along at least a portion of the tubular enclosure;
an upper high-voltage terminal and a lower high-voltage terminal electrically connected to opposite ends of the press-pack semiconductor switching stack; and
a pole-mount bracket configured to secure the tubular enclosure to a utility pole or crossarm such that the vertically oriented press-pack semiconductor switching stack is aligned substantially along the pole axis.

14. The pole-mounted cylindrical high-voltage solid-state switching device of claim 13, wherein the tubular enclosure further comprises external cooling fins formed along at least a portion of its length to enhance convective heat transfer to ambient air.

15. The pole-mounted cylindrical high-voltage solid-state switching device of claim 13, wherein the dielectric-filled cavity within the tubular enclosure contains an oil-immersed heat exchanger thermally coupled to the press-pack semiconductor switching stack.

16. The pole-mounted cylindrical high-voltage solid-state switching device of claim 13, wherein the pole-mount bracket is configured as a dual-arm gallows-type support adapted to withstand wind and ice loading consistent with utility design standards.

17. A modular multi-module high-voltage switching rack comprising:
a structural rack frame;
a plurality of switching modules mounted to the rack frame, each switching module including a press-pack semiconductor switching stack, a dielectric sub-chamber, and an associated heat-dissipation structure;
an upper bus-bar assembly and a lower bus-bar assembly configured to provide electrical interconnection among the plurality of switching modules in at least one of a series configuration, a parallel configuration, and a hybrid series-parallel configuration; and
dielectric partitions disposed between adjacent switching modules and between the switching modules and the rack frame to increase creepage and clearance distances.

18. The modular multi-module high-voltage switching rack of claim 17, wherein the plurality of switching modules are arranged vertically within the structural rack frame to promote natural convection cooling from bottom to top.

19. The modular multi-module high-voltage switching rack of claim 17, wherein the structural rack frame is mounted within an enclosure using shock-absorbing mounts configured to meet seismic design criteria for substation installations.

20. The modular multi-module high-voltage switching rack of claim 17, wherein the upper bus-bar assembly and lower bus-bar assembly include extended creepage surfaces configured to reduce electric field stress in the vicinity of high-voltage connections.

21. A high-voltage solid-state control system for a switching device, the control system comprising:
a high-potential gate-drive circuit disposed within a high-voltage region of an enclosure and electrically referenced to the potential of a press-pack semiconductor switching stack;
an optically isolated communication interface coupling the high-potential gate-drive circuit to a ground-potential controller;
a sensor suite disposed proximate to the press-pack semiconductor switching stack and configured to measure at least one of current, voltage, phase angle, temperature, and harmonic content; and
a switching controller configured to schedule and issue gate-drive commands based at least in part on measured waveform information, including alignment of switching events to current and/or voltage zero-crossings.

22. The high-voltage solid-state control system of claim 21, wherein the sensor suite comprises at least one current sensor, at least one voltage sensor, and at least one temperature sensor affixed to a surface of the press-pack semiconductor switching stack.

23. The high-voltage solid-state control system of claim 21, wherein the switching controller is configured to inhibit switching operations if a measured temperature exceeds a predetermined threshold or if measured harmonic distortion exceeds a predetermined limit.

24. The high-voltage solid-state control system of claim 21, wherein the optically isolated communication interface is further configured to transmit status, event, and waveform data to a remote monitoring or control center.

25. A bidirectional high-voltage solid-state switching system comprising:
a first semiconductor switching branch configured to conduct current in a forward direction;
a second semiconductor switching branch configured to conduct current in a reverse direction, the second semiconductor switching branch being arranged antiparallel to the first semiconductor switching branch;
a directional measurement subsystem configured to determine at least one of real-power flow direction, reactive-power flow direction, and phase-angle relationship between voltage and current; and
a directional control processor configured to selectively enable or block switching of at least one of the first semiconductor switching branch and the second semiconductor switching branch based on output of the directional measurement subsystem.

26. The bidirectional high-voltage solid-state switching system of claim 25, wherein the directional measurement subsystem utilizes phasor measurements derived from synchronized sampling of voltage and current waveforms to determine power-flow direction.

27. The bidirectional high-voltage solid-state switching system of claim 25, wherein the directional control processor is configured to block reverse power flow into a designated source bus during fault-isolation or islanding-prevention operations.

28. The bidirectional high-voltage solid-state switching system of claim 25, wherein the bidirectional high-voltage solid-state switching system is associated with an intertie or tie-switch location connecting two distribution feeders or substations.

29. A harmonic-mitigation solid-state switching device comprising:
a press-pack semiconductor switching assembly;
a harmonic detection processor configured to analyze a power-system waveform and identify one or more harmonic components above a predetermined amplitude threshold;
a timing controller configured to delay, advance, or suppress one or more switching events based on the harmonic components identified by the harmonic detection processor; and
a harmonic-mitigation network comprising at least one of an active snubber circuit, a tuned LC filter, and a digital gating algorithm, the harmonic-mitigation network being configured to reduce at least one of switching losses, electromagnetic interference, and waveform distortion during operation in an electric power system.

30. The harmonic-mitigation solid-state switching device of claim 29, wherein the harmonic detection processor is configured to detect at least one of third, fifth, seventh, eleventh, and thirteenth-order harmonic components exceeding a programmed threshold.

31. The harmonic-mitigation solid-state switching device of claim 29, wherein the harmonic-mitigation network includes a digitally controlled snubber circuit whose parameters are adaptively adjusted based on measured harmonic content.

32. The harmonic-mitigation solid-state switching device of claim 29, wherein the timing controller is configured to avoid executing switching events during identified harmonic peaks in order to reduce stress on the semiconductor devices and connected equipment.

33. A dielectric-segmented high-voltage housing for a solid-state switching assembly comprising:
a plurality of internal dielectric chambers arranged longitudinally or laterally with respect to a press-pack semiconductor switching stack;
one or more dielectric walls or baffles separating adjacent dielectric chambers and configured to increase effective creepage and clearance distances; and
a fluid or gas insulating medium contained within at least one of the dielectric chambers, the insulating medium being selected from air, nitrogen, insulating oil, fluorinated dielectric gas, SF₆-free insulating gas, and combinations thereof, wherein the dielectric chambers are configured to enhance insulation performance and permit compact packaging of the solid-state switching assembly.

34. The dielectric-segmented high-voltage housing of claim 33, wherein at least one of the dielectric chambers contains an insulating liquid and at least one other dielectric chamber contains an insulating gas, the combination being selected to optimize both thermal and dielectric performance.

35. The dielectric-segmented high-voltage housing of claim 33, wherein the dielectric walls or baffles are shaped to increase surface creepage paths and to reduce localized electric field concentrations near high-voltage conductors.

36. The dielectric-segmented high-voltage housing of claim 33, wherein at least one dielectric chamber includes turbulence-promoting structures configured to enhance convective flow of the insulating medium during thermal loading.

37. An integrated high-voltage solid-state grid-switching device comprising:
a packaged assembly, device, rack, system, or housing according to any one of claims 1-9; and
an embedded automation controller configured to communicate with at least one of a SCADA system, a distribution automation system, and a fault-location, isolation, and service-restoration system, the embedded automation controller being further configured to execute at least one of automatic feeder transfer, sectionalizing, loop-closing, and islanding-prevention operations using the packaged solid-state switching apparatus.

38. The device of claim 37, wherein the embedded automation controller is configured to execute automatic feeder-transfer sequences in response to a detected loss-of-source condition on a first feeder, by transferring load to a second feeder via the packaged solid-state switching apparatus.

39. The device of claim 37, wherein the embedded automation controller is configured to coordinate operation of the packaged solid-state switching apparatus with one or more upstream or downstream protection devices based on time-current or directional protection settings.

40. The device of claim 37, wherein the embedded automation controller is configured to participate in a fault-location, isolation, and service-restoration scheme that automatically isolates faulted sections and restores service to unfaulted sections using the packaged solid-state switching apparatus.
